(19) United States
(12) Patent Application Publication
(10) Pub. No.: US 2024/0228777 A1
(43) Pub. Date: Jul. 11, 2024

(54) BLOW MOLDING COMPOSITIONS BASED ON BRANCHED POLYAMIDES AND USES THEREOF

(71) Applicant: ARKEMA FRANCE, COLOMBES (FR)

(72) Inventors: Thomas PRENVEILLE, Serquigny (FR); Marjorie MARCOURT, Serquigny (FR); Bertrand VERBAUWHEDE, Serquigny (FR); Regis CIPRIANI, Serquigny (FR)

(73) Assignee: ARKEMA FRANCE, COLOMBES (FR)

(21) Appl. No.: 18/573,664

(22) PCT Filed: Jun. 24, 2022
(86) PCT No.: PCT/FR2022/051247

§ 371 Date: Dec. 22, 2023

(30) Foreign Application Priority Data
Jun. 28, 2021 (FR) FR2106903

(51) Int. Cl. C08L 77/00; B29C 49/00; B29C 49/22; B29K 77/00; B29K 105/00; B29L 31/00; B32B 1/08; B32B 27/08; B32B 27/30; B32B 27/34; C08L 77/06

(52) U.S. Cl. CPC C08L 77/00; B32B 1/08; B32B 27/08; B32B 27/306; B32B 27/34; C08L 77/06; B29C 49/0005; B29C 49/22; B29K 2077/00; B29K 2105/0094; B29L 2031/7172; B32B 2250/24; B32B 2307/7244; B32B 2439/40

(57) ABSTRACT

The present invention relates to a composition for blow-molding or extrusion, in particular blow-molding, comprising by weight: a) from 88 to 99.95%, more particularly from 89 to 99.9%, in particular from 93 to 99.9%, of at least one semicrystalline aliphatic polyamide having a carbon number per nitrogen atom of greater than or equal to 7, more particularly greater than or equal to 8, b) from 0.05% to 10%, more particularly from 0.1% to 9%, in particular from 0.1% to 5% by weight of at least one branching agent chosen from polyepoxides, polyanhydrides, more particularly polymaleic anhydrides and polyepoxides, c) from 0 to 2% of at least one additive, more particularly from 0.1 to 2%, the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%, the sum of the constituents a)+b)+c) making 100% by weight.

### TECHNICAL FIELD

The present invention relates to compositions for blow-molding or extrusion, in particular for blow-molding, based on branched polyamide and to their use for the preparation of monolayer or multilayer tubular structures intended for the transport, distribution or storage of gasoline, in particular alcohol-containing gasoline, and to the process for preparing said structures.

### PRIOR ART

For the transport and storage of gasoline and more particularly of biogasoline, there are numerous criteria to be met, more particularly good barrier properties (for reasons of environmental protection), low-temperature impact properties, pressure resistance properties, etc.

For reasons of safety and environmental preservation, particularly with the arrival of new biofuels, automobile manufacturers are subjecting the aforesaid tubes to particular mechanical characteristics, and also to characteristics of very low permeability and high resistance to the various constituents of the fuels, which vary according to country (hydrocarbons, additives, alcohols such as methanol and ethanol—the alcohols may in certain cases be majority components), to the engine lubricating oils and to the other chemical products that may be encountered in this environment (battery acid, brake fluids, cooling fluids, metal salts such as calcium chloride or zinc chloride).

The characteristics in the specifications commonly required by automobile manufacturers for a tube or tank to be judged satisfactory are, cumulatively, as follows:
good and lasting inter-layer adhesion, if the tube or the tank is a multilayer tube or tank, especially after exposure to the fuel;
good integrity of bonds (for tubes with connections) after circulation of the fuel, thus not resulting in any leakage;
good dimensional stability of the tube or the tank when used with gasoline;
good low-temperature (from about −30° C. to −40° C.) impact resistance, so that the tube or the tank does not break;
good high-temperature (about 150° C.) resistance, so that the tube or the tank does not deform;
good aging resistance in a hot oxidative environment (for example: hot air in the engine compartment, from about 100 to 150° C.);
good resistance to the fuels and their degradation products, especially with high levels of peroxide;
very low permeability to the fuels, and more particularly good barrier properties to the biofuels, both for the polar components (such as ethanol) and for the apolar components (hydrocarbons) therein;
good flexibility of the tube or the tank, to facilitate the assembly especially of the fuel supply tubing;
good resistance to ZnCl2 (for example, in winter, when the roads are salted, since the outside of the tube is exposed to this environment);
sufficiently high viscosity at low shear rate so that the parison has good integrity during blow-molding.

Moreover, the required tubes or tanks must not have the following drawbacks:
if the tube or the tank is a multilayer tube or tank, there must be no delamination of the layers, especially inner layers, especially during the insertion of a connection (which can lead to leaks);
there must be no excessive swelling of the tube or the tank after aging in gasoline/diesel systems (including those for biodiesels or biogasolines), which can lead to leaks or to positioning problems under the vehicle.

Application EP 0495363 relates to polyamide compositions based on a polyamide (PA) alloy and on special olefin-acid anhydride copolymers and to their use for producing shaped hollow bodies.

Nevertheless, the compositions exemplified are too fluid to allow large tanks to be extruded.

These structures are also based on polyamide 6 (PA 6) (poor resistance to zinc chloride and brittle when cold) and are therefore not compatible with applications for tanks for automotive fluids (gasolines).

International application WO20027031 relates to a composition based on PA 6, impact modifier and metal halide.

As above, these structures are based on PA 6 (poor resistance to zinc chloride and brittle when cold) and are therefore not compatible with applications for tanks for automotive fluids such as gasoline.

Application CA3101967 relates to polyamide compositions for blow-molding based on PA 6 and impact modifier and consequently they have the same problems as above.

Application EP1352934 describes metal surfaces coated with a polyamide-based layer consisting of a mixture of polyamide and of a polyolefin functionalized with an unsaturated carboxylic acid anhydride.

Application US2005/228145 describes a transparent multilayer structure comprising a first polyamide layer consisting of a mixture of polyamide and a polyolefin functionalized with a maleic anhydride.

Application FR3078132 describes a flexible tubular structure comprising a layer comprising a mixture of polyamide and a polyolefin functionalized with an anhydride.

It is therefore necessary to provide compositions which overcome the problems presented above and the present invention therefore relates to a composition for blow-molding or extrusion, in particular blow-molding, comprising by weight:
a) from 88 to 99.95%, more particularly from 89 to 99.9%, in particular from 93 to 99.9%, of at least one semicrystalline aliphatic polyamide having a carbon number per nitrogen atom of greater than or equal to 7, more particularly greater than or equal to 8,
b) from 0.05% to 10%, more particularly from 0.1% to 9%, in particular from 0.1% to 5% by weight of at least one branching agent chosen from polyepoxides, polymaleic anhydrides and polyisocyanates,
c) from 0 to 2% of at least one additive, more particularly from 0.1 to 2%,
the composition having, after compounding, a melt viscosity of from 10 000 to 300 000 Pa·s, preferably from 15 000 to 220 000 Pa·s, as measured in plane-plane geometry at a temperature of 250° C., a frequency of 0.292 rad/s and a deformation of 2%,
the sum of the constituents a)+b)+c) making 100% by weight.

The inventors have therefore unexpectedly found that the use of particular semicrystalline aliphatic polyamides with a particular range of branching agent and the presence or absence of additives made it possible to obtain compositions which, after compounding, have a melt viscosity within a range permitting extrusion-blow-molding for the constitution of a monolayer or multilayer tubular structure intended for the transport, distribution or storage of gasoline, in particular alcoholized gasoline.

The term “monolayer or multilayer tubular structure” is understood to mean a tank comprising or consisting of one or more layers.

The multilayer structure in the present invention also designates a pipe or a tube for transporting gasoline to the tank and from the tank to the engine or located beneath the engine hood and comprising or consisting of one or more layers.

Another advantage of the compositions of the invention is good dimensional stability, that is to say a low water uptake and good resistance to zinc chloride.

In one embodiment, non-functionalized impact modifiers are excluded from said composition.

In another embodiment, non-functionalized impact modifiers and impact modifiers with little functionalization are excluded from said composition.

The term “impact modifier with little functionalization” is understood to mean an impact modifier having an equivalent weight per reactive function of greater than 10 000 g/mol, advantageously greater than 6000 g/mol.

The equivalent weight per reactive function is calculated by dividing the average molar mass of the molecule by the number of reactive functions.

In yet another embodiment, functionalized or non-functionalized impact modifiers are excluded from said composition.

In yet another embodiment, non-functionalized elastomers are excluded from said composition.

In another embodiment, the plasticizer content in the composition is less than 5% by weight, advantageously less than 2%.

In yet another embodiment, plasticizers are excluded from said composition.

### The Optionally Excluded Impact Modifier

The expression “impact modifier” is to be understood to mean a polymer with a modulus lower than that of the resin, exhibiting good adhesion with the matrix, so as to dissipate the cracking energy.

The impact modifier is advantageously constituted by a polymer having a flexural modulus of less than 100 MPa measured according to ISO standard 178 and a Tg of less than 0° C. (measured according to standard 11357-2 at the point of inflection of the DSC thermogram), in particular a polyolefin.

The polyolefin of the impact modifier can be functionalized or nonfunctionalized or be a mixture of at least one which is functionalized and/or of at least one which is nonfunctionalized. To simplify, the polyolefin has been denoted (B) and functionalized polyolefins (B1) and nonfunctionalized polyolefins (B2) have been described below.

A nonfunctionalized polyolefin (B2) is conventionally a homopolymer or copolymer of alpha-olefins or diolefins, such as, for example, ethylene, propylene, 1-butene, 1-octene, butadiene. Mention may be made, by way of example, of:
polyethylene homopolymers and copolymers, in particular LDPE, HDPE, LLDPE (linear low density polyethylene), VLDPE (very low density polyethylene) and metallocene polyethylene.
propylene homopolymers or copolymers,
ethylene/aIpha-olefin copolymers such as ethylene/propylene, EPR (abbreviation for ethylene-propylene-rubber) and ethylene/propylene/diene (EPDM) copolymers.
styrene/ethylene-butene/styrene block copolymers (SEBS), styrene/butadiene/styrene block copolymers (SBS), styrene/isoprene/styrene block copolymers (SIS), styrene/ethylene-propylene/styrene block copolymers (SEPS).
copolymers of ethylene with at least one product chosen from salts or esters of unsaturated carboxylic acids such as alkyl (meth)acrylate (for example methyl acrylate), or vinyl esters of saturated carboxylic acids such as vinyl acetate (EVA), where the proportion of comonomer can reach 40% by weight.

The functionalized polyolefin (B1) may be a polymer of alpha-olefins having reactive units (functionalities); such reactive units are acid, anhydride or epoxy functions. Mention may be made, by way of example, of the preceding polyolefins (B2) grafted or copolymerized or terpolymerized by unsaturated epoxides, such as glycidyl (meth)acrylate, or by carboxylic acids or the corresponding salts or esters, such as (meth)acrylic acid (it being possible for the latter to be completely or partially neutralized by metals such as Zn, and the like), or else by carboxylic acid anhydrides, such as maleic anhydride. A functionalized polyolefin is, for example, a PE/EPR mixture, the weight ratio of which may vary widely, for example from 40/60 to 90/10, said mixture being co-grafted with an anhydride, in particular maleic anhydride, according to a degree of grafting, for example, of 0.01 to 5% by weight, advantageously from 2.8 to 5% by weight.

The functionalized polyolefin (B1) may be chosen from the following (co)polymers, grafted with maleic anhydride or glycidyl methacrylate, in which the degree of grafting is for example from 0.01% to 5% by weight:
PE, PP, copolymers of ethylene with propylene, butene, hexene or octene containing, for example, from 35% to 80% by weight of ethylene;
ethylene/alpha-olefin copolymers such as ethylene/propylene, EPR (abbreviation for ethylene-propylene-rubber) and ethylene/propylene/diene (EPDM) copolymers.
styrene/ethylene-butene/styrene block copolymers (SEBS), styrene/butadiene/styrene block copolymers (SBS), styrene/isoprene/styrene block copolymers (SIS), styrene/ethylene-propylene/styrene block copolymers (SEPS).
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) can also be chosen from ethylene/propylene copolymers, predominant in propylene, grafted with maleic anhydride and then condensed with monoaminated polyamide (or polyamide oligomer) (products described in EP-A-0342066).

The functionalized polyolefin (B1) can also be a copolymer or terpolymer of at least the following units: (1) ethylene, (2) alkyl (meth)acrylate or saturated carboxylic acid vinyl ester and (3) anhydride, such as maleic or (meth)acrylic acid anhydride, or epoxy, such as glycidyl (meth)acrylate.

As examples of functionalized polyolefins of the latter type, mention may be made of the following copolymers, in which the ethylene preferably represents at least 60% by weight and in which the ter monomer (the function) represents, for example, from 0.1 to 13% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” in (B1) or (B2) denotes C1 to C8 alkyl methacrylates and acrylates and can be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) may also be crosslinked by any suitable method or agent (diepoxy, diacid, peroxide, etc.); the term functionalized polyolefin also comprises mixtures of the abovementioned polyolefins with a bifunctional reagent such as diacid, dianhydride, diepoxy, etc., capable of reacting with these polyolefins or mixtures of at least two functionalized polyolefins which may react with one another.

The abovementioned copolymers, (B1) and (B2), can be copolymerized in random or block fashion and exhibit a linear or branched structure.

The molecular weight, the MFI index and the density of these polyolefins can also vary within a broad range, which will be perceived by a person skilled in the art. MFI is the abbreviation for Melt Flow Index. It is measured according to ASTM standard 1238 or ISO standard 1133:2011.

The nonfunctionalized polyolefins (B2) are advantageously chosen from polypropylene homopolymers or copolymers, and any ethylene homopolymer, or copolymer of ethylene and of a comonomer of higher alpha-olefin type, such as butene, hexene, octene or 4-methyl-1-pentene.

Mention may be made, for example, of PPs, high density PEs, medium density PEs, linear low density PEs, low density PEs or ultra low density PEs. These polyethylenes are known to those skilled in the art as being produced according to a “radical” process, according to a “Ziegler”-type catalysis or, more recently, according to a “metallocene” catalysis.

Advantageously, the functionalized polyolefins (B1) are chosen from any polymer comprising alpha-olefinic units and units carrying polar reactive functions such as epoxy, carboxylic acid or carboxylic acid anhydride functions. As examples of such polymers, mention may be made of the ter polymers of ethylene, alkyl acrylate and maleic anhydride or glycidyl methacrylate, such as Lotader® from SK global chemical, or polyolefins grafted with maleic anhydride, such as Orevac® from SK global chemical, as well as ter polymers of ethylene, alkyl acrylate and (meth)acrylic acid. Mention may also be made of polypropylene homopolymers or copolymers grafted with a carboxylic acid anhydride and then condensed with polyamides or monoamine oligomers of polyamide.

### The Semicrystalline Aliphatic Polyamide

The composition for blow-molding or extrusion, in particular blow-molding, comprises from 88 to 99.95%, more particularly from 89 to 99.8%, of at least one semicrystalline aliphatic polyamide having a carbon number per nitrogen atom of greater than or equal to 7, more particularly greater than or equal to 8.

The nomenclature used to define polyamides is described in ISO standard 1874-1:2011 “Plastics—Polyamide (PA) moulding and extrusion materials—Part 1: Designation”, in particular on page 3 (Tables 1 and 2) and is well known to those skilled in the art.

The polyamide can be a homopolyamide or a copolyamide or a mixture thereof.

For the purposes of the invention, the term “semicrystalline” denotes a (co)polyamide which has a melting point (Tm) in DSC according to the standard ISO 11357-3:2013, and an enthalpy of crystallization during the cooling step at a rate of 20 K/min in DSC measured in accordance with the standard ISO 11357-3 of 2013 which is greater than 20 J/g, preferably greater than 30 J/g.

Said semicrystalline aliphatic polyamide is derived from a repeating unit obtained by polycondensation:
of at least one C9 to C18 amino acid, preferably C10 to C18 amino acid, more preferably C10 to C12 amino acid, or
of at least one C9 to C18 lactam, preferably C10 to C18 lactam, more preferably C10 to C12 lactam, or
of at least one C4-C36, preferably C6-C18, preferably C6-C12, more preferably C10-C12 diamine Ca, with at least one C4-C36, preferably C6-C18, preferably C6-C12, more preferably C10-C12 dicarboxylic acid Cb,
or a mixture thereof,
provided that the number of carbon atoms per nitrogen atom in the repeating unit is greater than or equal to 7, in particular greater than or equal to 8.

A C9 to C18 amino acid is in particular 9-aminononanoic acid, 10-aminodecanoic acid, 10-aminoundecanoic acid, 12-aminododecanoic acid and 11-aminoundecanoic acid, as well as derivatives thereof, in particular N-heptyl-11-aminoundecanoic acid.

A C9 to C18 lactam is in particular lauryllactam.

Said at least one C4-C36 diamine Ca may be chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine Ca is C6-C18 and chosen from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Said at least one C4 to C36 dicarboxylic acid Cb may be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, octadecenediamine, eicosanediamine, docosanediamine and diamines obtained from fatty acids.

Advantageously, said at least one dicarboxylic acid Cb is C6 to C18 and is chosen from adipic acid, suberic acid, azelaic acid, sebacic acid and undecanedioic acid, dodecanedioic acid, brassylic acid, tetradecanedioic acid, pentadecanedioic acid, hexadecanedioic acid, octadecanedioic acid.

In one embodiment, said semicrystalline aliphatic polyamide is chosen from PA610, PA612, PA 614, PA 10, PA11 and PA12, in particular PA610, PA612 and PA11.

In one embodiment, said semicrystalline aliphatic polyamide is a mixture of two semicrystalline aliphatic polyamides having a carbon number per nitrogen atom of greater than or equal to 7, more particularly greater than or equal to 8, in a weight proportion range from 5/95 to 95/5.

Advantageously, the polyamide has an amine chain end concentration of from 5 to 60 μeq/g, very advantageously from 10 to 50 μeq/g.

Advantageously, the polyamide has an acid chain end concentration of from 5 to 60 μeq/g, very advantageously from 10 to 50 μeq/g.

The amine chain ends are measured according to the following method: a polyamide sample is dissolved in metacresol. This sample is then assayed by potentiometry with 0.02 perchloric acid solution.

The acid chain ends are measured according to the method below. A sample of polyamide is dissolved in benzyl alcohol. This sample is then assayed by potentiometry with 0.02 N tetrabutylammonium hydroxide solution.

In one embodiment, the MFI of said polyamide or of said polyamide mixture is from 0.01 to 10, advantageously from 0.01 to 5 g/10 min at 235° C., 5 kg.

The polyamide according to the invention has an inherent viscosity in m-cresol of greater than 1.45, advantageously greater than 1.55, very advantageously greater than 1.6, as determined according to ISO standard 307:2007, but using m-cresol instead of sulfuric acid, a temperature of 20° C. and a concentration of 0.5% by mass.

### The Branching Agent

The branching agent is present in the composition from 0.05% to 10%, more particularly from 0.1% to 9%, in particular from 0.1% to 5% by weight and is chosen from polyepoxides, polyanhydrides and polyisocyanates, more particularly polymaleic anhydrides and polyepoxides.

In one embodiment, the branching agent is present in the composition from 0.1 to 2% by weight.

The branching agent may be an impact modifier, in particular a functionalized polyolefin, or different from an impact modifier.

Advantageously, it is different from the impact modifier. That is to say that it has a Tg greater than −30° C., very advantageously greater than 0° C.

Advantageously, the equivalent weight per reactive function of the branching agent is from 100 to 10 000 g/mol, advantageously from 120 to 6000 g/mol, very advantageously from 140 to 3300 g/mol.

In one embodiment, said branching agent has an average functionality in terms of epoxy, anhydride or isocyanate functions of from 1.8 to 200, preferably from 2.1 to 150.

In another embodiment, the equivalent weight per reactive function of the branching agents is from 100 to 10 000 g/mol, advantageously from 120 to 6000 g/mol, very advantageously from 140 to 3300 g/mol.

In yet another embodiment, the molar mass of the branching agents is from 300 to 120 000 g/mol, preferably from 400 to 100 000 g/mol.

The molar mass is measured by gas chromatography (GC).

The equivalent weight per reactive function of the branching agents is measured as follows:

Isocyanates: The equivalent weight per isocyanate function is measured according to the AFNOR standard referenced NFT52-132.

Epoxides: The equivalent weight per epoxide function is measured according to ASTM standard D1652-11(2019).

Maleic anhydride: The content by mass of maleic anhydride is measured by FTIR according to the method of De Roovers et al. [J Polym Sci, Part A: Polym Chem 1995; 33:829].

The equivalent weight is often given by the supplier on the TDS.

The average functionality is calculated by dividing the molar mass measured by GC by the average equivalent weight.

The polyepoxides may be copolymers manufactured from glycidyl maleic anhydride (GMA) or any other monomer comprising an epoxy function.

Examples of commercial polyepoxides are, for example, Xibond® 920 sold by Polyscope or Joncryl® ADR 4400 sold by BASF or Lotader® AX 8900 sold by SK global chemical.

The polyanhydrides may be copolymers comprising a copolymerized or grafted anhydride, such as maleic anhydride or itaconic anhydride.

In particular, the polyanhydrides are polymaleic anhydrides.

The other monomer of the copolymers comprising a copolymerized anhydride may be a vinyl aromatic monomer, such as styrene or styrenes in which the aromatic ring contains a halogen or an alkyl substituent.

In one embodiment, the other monomer of the copolymers comprising a copolymerized anhydride may be a vinyl monomer, such as ethylene or octadecene.

In particular, the polymaleic anhydrides are copolymers of styrene and maleic anhydride.

Examples of commercial polymaleic anhydrides are, for example, Xibond® 125 (copolymer of styrene and maleic anhydride) sold by Polyscope or Orevac IM 800 sold by SK global chemical or PA 18 (copolymer of 1-octadecene and maleic anhydride) sold by Chevron Phillips Chemical Company.

The polyisocyanates are preferably oligomers of isocyanates such as isocyanurates or allophanates.

Examples of commercial polyisocyanates are, for example, Desmodur 3300 sold by Covestro.

### The Additive

The additives may be present up to 2% by weight relative to the total weight of the composition, in particular they are present from 0.1% to 2% by weight relative to the total weight of the composition.

The additive may be selected from a catalyst, an antioxidant, a heat stabilizer, a UV stabilizer, a light stabilizer, a lubricant, a flame retardant, a nucleating agent, a chain extender and a dye.

In one embodiment, the additive is selected from a catalyst, an antioxidant, a heat stabilizer, a UV stabilizer, a light stabilizer, a lubricant, a flame retardant, a chain extender and a dye.

The term “catalyst” denotes a polycondensation catalyst such as a mineral or organic acid.

Advantageously, the weight proportion of catalyst is from about 50 ppm to about 5000 ppm, in particular from about 100 to about 3000 ppm relative to the total weight of the composition.

Advantageously, the catalyst is chosen from phosphoric acid (H3PO4), phosphorous acid (H3PO3) and hypophosphorous acid (H3PO2), or a mixture thereof.

The antioxidant may especially be an antioxidant based on a copper complex of from 0.05% to 5% by weight, preferably from 0.05% to 1% by weight, preferably from 0.1% to 1%.

The term “copper complex” especially denotes a complex between a monovalent or divalent copper salt with an organic or inorganic acid and an organic ligand.

Advantageously, the copper salt is chosen from cupric (Cu(II)) salts of hydrogen halide, cuprous (Cu(I)) salts of hydrogen halide and aliphatic carboxylic acid salts.

In particular, the copper salts are chosen from CuCl, CuBr, CUI, CuCN, CuCl2, Cu(OAC)2, cupric stearate.

Copper complexes are described especially in U.S. Pat. No. 3,505,285.

Said copper-based complex may also comprise a ligand chosen from phosphines, in particular triphenylphosphines, mercaptobenzimidazole, EDTA, acetylacetonate, glycine, ethylene diamine, oxalate, diethylene diamine, triethylene tetraamine, pyridine, tetrabromobisphenyl-A, tetrabisphenyl-A derivatives, such as epoxy derivatives, and derivatives of chlorodimethanedibenzo(a,e)cyclooctene and mixtures thereof, diphosphone and dipyridyl or mixtures thereof, in particular triphenylphosphine and/or mercaptobenzimidazole.

The phosphines denote alkylphosphines, such as tributylphosphine, or arylphosphines such as triphenylphosphine (TPP).

Advantageously, said ligand is triphenylphosphine.

Examples of complexes and also of their preparation are described in patent CA 02347258.

Advantageously, the amount of copper in the composition of the invention is from 10 ppm to 1000 ppm by weight, especially from 20 ppm to 70 ppm, in particular from 50 to 150 ppm relative to the total weight of the composition.

Advantageously, said copper-based complex also comprises a halogenated organic compound.

The halogenated organic compound may be any halogenated organic compound.

Advantageously, said halogenated organic compound is a bromine-based compound and/or an aromatic compound.

Advantageously, said aromatic compound is in particular chosen from decabromodiphenyl, decabromodiphenyl ether, bromo- or chloro-styrene oligomers and polydibromostyrene.

Advantageously, said halogenated organic compound is a bromine-based compound.

Said halogenated organic compound is added to the composition in a proportion of from 50 to 30 000 ppm by weight of halogen relative to the total weight of the composition, especially from 100 to 10 000, in particular from 500 to 1500 ppm.

Advantageously, the copper:halogen molar ratio is from 1:1 to 1:3000, in particular from 1:2 to 1:100.

In particular, said ratio is from 1:1.5 to 1:15.

Advantageously, the antioxidant based on copper complex.

The heat stabilizer may be an organic stabilizer or more generally a combination of organic stabilizers, such as a primary antioxidant of phenol type (for example of the type of that of irganox 245 or 1098 or 1010 from Ciba), or a secondary antioxidant of phosphite type.

The UV stabilizer may be an HALS, which means Hindered Amine Light Stabilizer, or an anti-UV agent (for example Tinuvin 312 from Ciba).

The light stabilizer may be of the hindered amine type (for example Tinuvin 770 from Ciba), a phenolic stabilizer or a phosphorus-based stabilizer.

The lubricant may be a fatty acid type lubricant such as stearic acid.

The flame retardant may be a halogen-free flame retardant, as described in US 2008/0274355, and in particular a phosphorus-based flame retardant, for example a metal salt chosen from a metal salt of phosphinic acid, more particularly dialkyl phosphinate salts, in particular aluminum diethylphosphinate salt or aluminum diethylphosphinate, a metal salt of diphosphinic acid, a mixture of aluminum phosphinate-based flame retardant and a nitrogen synergist or a mixture of aluminum phosphinate-based flame retardant and a phosphorus synergist, a polymer containing at least one metal salt of phosphinic acid, in particular on an ammonium basis such as ammonium polyphosphate, sulfamate or pentaborate, or on a melamine basis such as melamine, melamine salts, melamine pyrophosphates and melamine cyanurates, or on a cyanuric acid basis, or else a polymer containing at least one metal salt of diphosphinic acid or red phosphorus, an antimony oxide, a zinc oxide, an iron oxide, a magnesium oxide or metal borates such as a zinc borate, or phosphazene, a phospham or phosphoxynitride or a mixture thereof. They may also be halogenated flame retardants such as a brominated or polybrominated polystyrene, a brominated polycarbonate or a brominated phenol.

The nucleating agent may be silica, alumina, clay or talc, in particular talc.

Examples of suitable chain regulators are monoamines, monocarboxylic acids, diamines, triamines, dicarboxylic acids, tricarboxylic acids, tetraamines, tetracarboxylic acids, and oligoamines or oligocarboxylic acids having in each case, respectively, 5 to 8 amino or carboxyl groups and in particular dicarboxylic acids, tricarboxylic acids or a mixture of dicarboxylic acids and of tricarboxylic acids. By way of example, it is possible to use dodecanedicarboxylic acid in dicarboxylic acid form and trimellitic acid as tricarboxylic acid.

### The Composition

Throughout the description, all the percentages are indicated by weight.

The composition for blow-molding or extrusion, in particular blow-molding, comprises by weight:
a) from 88 to 99.95%, more particularly from 89 to 99.9%, in particular from 93 to 99.9%, of at least one semicrystalline aliphatic polyamide having a carbon number per nitrogen atom of greater than or equal to 7, more particularly greater than or equal to 8,
b) from 0.05% to 10%, more particularly from 0.1% to 9%, in particular from 0.1% to 5% by weight of at least one branching agent chosen from polyepoxides, polyanhydrides and polyisocyanates, more particularly polymaleic anhydrides and polyepoxides,
c) from 0 to 2% of at least one additive, more particularly from 0.1 to 2%,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

In one embodiment, the composition for blow-molding or extrusion, in particular blow-molding, consists by weight of:
a) from 88 to 99.95%, more particularly from 89 to 99.9%, in particular from 93 to 99.9%, of at least one semicrystalline aliphatic polyamide having a carbon number per nitrogen atom of greater than or equal to 7, more particularly greater than or equal to 8,
b) from 0.05% to 10%, more particularly from 0.1% to 9%, in particular from 0.1% to 5% by weight of at least one branching agent chosen from polyepoxides, polyanhydrides and polyisocyanates, more particularly polymaleic anhydrides and polyepoxides,
c) from 0 to 2% of at least one additive, more particularly from 0.1 to 2%,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

In one embodiment, said composition comprises:
a) from 88 to 99.95% of at least one semicrystalline aliphatic polyamide having a carbon number per nitrogen atom of greater than or equal to 7, more particularly greater than or equal to 8,
b) from 0.05% to 10% by weight of at least one branching agent chosen from polyepoxides, polyanhydrides and polyisocyanates, more particularly polymaleic anhydrides and polyepoxides,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b) making 100% by weight.

Advantageously, in this embodiment, said composition consists of:
a) from 88 to 99.95% of at least one semicrystalline aliphatic polyamide having a carbon number per nitrogen atom of greater than or equal to 7, more particularly greater than or equal to 8,
b) from 0.05% to 10% by weight of at least one branching agent chosen from polyepoxides, polyanhydrides and polyisocyanates, more particularly polymaleic anhydrides and polyepoxides,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b) making 100% by weight.

In another embodiment, said composition comprises:
a) from 88 to 99.85% of at least one semicrystalline aliphatic polyamide having a carbon number per nitrogen atom of greater than or equal to 7, more particularly greater than or equal to 8,
b) from 0.05% to 10% by weight of at least one branching agent chosen from polyepoxides, polyanhydrides and polyisocyanates, more particularly polymaleic anhydrides and polyepoxides,
c) from 0.1 to 2% of at least one additive,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

Advantageously, in this embodiment, said composition consists of:
a) from 88 to 99.85% of at least one semicrystalline aliphatic polyamide having a carbon number per nitrogen atom of greater than or equal to 7, more particularly greater than or equal to 8,
b) from 0.05% to 10% by weight of at least one branching agent chosen from polyepoxides, polyanhydrides and polyisocyanates, more particularly polymaleic anhydrides and polyepoxides,
c) from 0.1 to 2% of at least one additive,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

In a first variant, said composition comprises:
a) from 89 to 99.9% of at least one semicrystalline aliphatic polyamide having a carbon number per nitrogen atom of greater than or equal to 7, more particularly greater than or equal to 8,
b) from 0.1 to 9% by weight of at least one branching agent chosen from polyepoxides, polyanhydrides and polyisocyanates, more particularly polymaleic anhydrides and polyepoxides,
c) from 0 to 2% of at least one additive, more particularly from 0.1 to 2%,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

In one embodiment of this first variant, said composition comprises:
a) from 89 to 99.9% of at least one semicrystalline aliphatic polyamide having a carbon number per nitrogen atom of greater than or equal to 7, more particularly greater than or equal to 8,
b) from 0.1 to 9% by weight of at least one branching agent chosen from polyepoxides, polyanhydrides and polyisocyanates, more particularly polymaleic anhydrides and polyepoxides,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b) making 100% by weight.

Advantageously, in this embodiment of this first variant, the composition consists of:
a) from 89 to 99.9% of at least one semicrystalline aliphatic polyamide having a carbon number per nitrogen atom of greater than or equal to 7, more particularly greater than or equal to 8,
b) from 0.1 to 9% by weight of at least one branching agent chosen from polyepoxides, polyanhydrides and polyisocyanates, more particularly polymaleic anhydrides and polyepoxides,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b) making 100% by weight.

In another embodiment of this first variant, said composition comprises:
a) from 89 to 99.8% of at least one semicrystalline aliphatic polyamide having a carbon number per nitrogen atom of greater than or equal to 7, more particularly greater than or equal to 8,
b) from 0.1 to 9% by weight of at least one branching agent chosen from polyepoxides, polyanhydrides and polyisocyanates, more particularly polymaleic anhydrides and polyepoxides,
c) from 0.1 to 2% of at least one additive,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

Advantageously, in this other embodiment of this first variant, the composition consists of:
a) from 89 to 99.8% of at least one semicrystalline aliphatic polyamide having a carbon number per nitrogen atom of greater than or equal to 7, more particularly greater than or equal to 8,
b) from 0.1 to 9% by weight of at least one branching agent chosen from polyepoxides, polyanhydrides and polyisocyanates, more particularly polymaleic anhydrides and polyepoxides,
c) from 0.1 to 2% of at least one additive,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

In a second variant, said composition comprises:
a) from 93 to 99.9% of at least one semicrystalline aliphatic polyamide having a carbon number per nitrogen atom of greater than or equal to 7, more particularly greater than or equal to 8,
b) from 0.1 to 5% by weight of at least one branching agent chosen from polyepoxides, polyanhydrides and polyisocyanates, more particularly polymaleic anhydrides and polyepoxides,
c) from 0 to 2% of at least one additive, more particularly from 0.1 to 2%,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

In one embodiment of this second variant, said composition comprises:
a) from 93 to 99.9% of at least one semicrystalline aliphatic polyamide having a carbon number per nitrogen atom of greater than or equal to 7, more particularly greater than or equal to 8,
b) from 0.1 to 5% by weight of at least one branching agent chosen from polyepoxides, polyanhydrides and polyisocyanates, more particularly polymaleic anhydrides and polyepoxides,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b) making 100% by weight.

Advantageously, in this embodiment of this second variant, said composition consists of:
a) from 93 to 99.9% of at least one semicrystalline aliphatic polyamide having a carbon number per nitrogen atom of greater than or equal to 7, more particularly greater than or equal to 8,
b) from 0.1 to 5% by weight of at least one branching agent chosen from polyepoxides, polyanhydrides and polyisocyanates, more particularly polymaleic anhydrides and polyepoxides,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b) making 100% by weight.

In another embodiment of this second variant, said composition comprises:
a) from 93 to 99.8% of at least one semicrystalline aliphatic polyamide having a carbon number per nitrogen atom of greater than or equal to 7, more particularly greater than or equal to 8,
b) from 0.1 to 5% by weight of at least one branching agent chosen from polyepoxides, polyanhydrides and polyisocyanates, more particularly polymaleic anhydrides and polyepoxides,
c) from 0.1 to 2% of at least one additive,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

Advantageously, in this other embodiment of this second variant, said composition consists of:
a) from 93 to 99.8% of at least one semicrystalline aliphatic polyamide having a carbon number per nitrogen atom of greater than or equal to 7, more particularly greater than or equal to 8,
b) from 0.1 to 5% by weight of at least one branching agent chosen from polyepoxides, polyanhydrides and polyisocyanates, more particularly polymaleic anhydrides and polyepoxides,
c) from 0.1 to 2% of at least one additive,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b)+c) making 100% by weight.

In a third variant, said composition comprises:
a) from 98 to 99.9% of at least one semicrystalline aliphatic polyamide having a carbon number per nitrogen atom of greater than or equal to 7, more particularly greater than or equal to 8,
b) from 0.1 to 2% by weight of at least one branching agent chosen from polyepoxides, polyanhydrides and polyisocyanates, more particularly polymaleic anhydrides and polyepoxides,
c) from 0 to 2% of at least one additive, more particularly from 0.1 to 2%,
the composition having, after compounding, a melt viscosity of from 10 000 to 300 000 Pa·s, preferably from 15 000 to 220 000 Pa·s, as measured in plane-plane geometry at a temperature of 250° C., a frequency of 0.292 rad/s and a deformation of 10%,
the sum of the constituents a)+b)+c) making 100% by weight.

In one embodiment of this third variant, said composition comprises:
a) from 98 to 99.9% of at least one semicrystalline aliphatic polyamide having a carbon number per nitrogen atom of greater than or equal to 7, more particularly greater than or equal to 8,
b) from 0.1 to 2% by weight of at least one branching agent chosen from polyepoxides, polyanhydrides and polyisocyanates, more particularly polymaleic anhydrides and polyepoxides,
the composition having, after compounding, a melt viscosity of from 10 000 to 300 000 Pa·s, preferably from 15 000 to 220 000 Pa·s, as measured in plane-plane geometry according to standard 6721-10:2015 at a temperature of 250° C., a frequency of 0.292 rad/s and a deformation of 2%,
the sum of the constituents a)+b) making 100% by weight.

Advantageously, in this embodiment of this third variant, said composition consists of:
a) from 98 to 99.9% of at least one semicrystalline aliphatic polyamide having a carbon number per nitrogen atom of greater than or equal to 7, more particularly greater than or equal to 8,
b) from 0.1 to 2% by weight of at least one branching agent chosen from polyepoxides, polyanhydrides and polyisocyanates, more particularly polymaleic anhydrides and polyepoxides,
the composition having, after compounding, a melt viscosity of from 10 000 to 300 000 Pa·s, preferably from 15 000 to 220 000 Pa·s, as measured in plane-plane geometry according to standard ISO 6721-10:2015 at a temperature of 250° C., a frequency of 0.292 rad/s and a deformation of 2%,
the sum of the constituents a)+b) making 100% by weight.

In another embodiment of this third variant, said composition comprises:
a) from 96 to 99.8% of at least one semicrystalline aliphatic polyamide having a carbon number per nitrogen atom of greater than or equal to 7, more particularly greater than or equal to 8,
b) from 0.1 to 2% by weight of at least one branching agent chosen from polyepoxides, polyanhydrides and polyisocyanates, more particularly polymaleic anhydrides and polyepoxides,
c) from 0.1 to 2% of at least one additive,
the composition having, after compounding, a melt viscosity of from 10 000 to 300 000 Pa·s, preferably from 15 000 to 220 000 Pa·s, as measured in plane-plane geometry according to standard ISO 6721-10:2015 at a temperature of 250° C., a frequency of 0.292 rad/s and a deformation of 2%,
the sum of the constituents a)+b)+c) making 100% by weight.

Advantageously, in this other embodiment of this third variant, said composition consists of:
a) from 96 to 99.8% of at least one semicrystalline aliphatic polyamide having a carbon number per nitrogen atom of greater than or equal to 7, more particularly greater than or equal to 8,
b) from 0.1 to 2% by weight of at least one branching agent chosen from polyepoxides, polyanhydrides and polyisocyanates, more particularly polymaleic anhydrides and polyepoxides,
c) from 0.1 to 2% of at least one additive,
the composition having, after compounding, a melt viscosity of from 10 000 to 300 000 Pa·s, preferably from 15 000 to 220 000 Pa·s, as measured in plane-plane geometry according to standard ISO 6721-10:2015 at a temperature of 250° C., a frequency of 0.292 rad/s and a deformation of 2%,
the sum of the constituents a)+b)+c) making 100% by weight.

In all the variants and embodiments of the compositions described above:
the MVR (volume flow index) as determined according to ISO 1133:2011 with a weight of 21.6 kg and at a temperature of 275° C. is from 2 to 25 cm³/10 min, advantageously from 5 to 20 cm³/10 min, very advantageously from 6 to 18 cm³/10 min.

In all the variants and embodiments of the compositions described above:

The MFI of the composition is from 0 to 5, advantageously from 0 to 0.1 g/10 min at 235° C., 1 kg according to ISO 1133: 2011.

The branching agent and the polyamide are linked by means of a covalent bond; advantageously the branching agent and the polyamide are linked by an amide, ester or urea function.

Advantageously at least 5% by weight, very advantageously at least 15% by weight of the polyamide is covalently bonded to the branching agent, the ratio of the melt viscosities as measured in plane-plane geometry at 0.292 rad·s⁻¹/292rad·s⁻¹ of said compositions is from 10 to 200, advantageously from 25 to 150. This ratio makes it possible to determine the degree of branching of the polyamide of said composition. The higher the ratio, the more branched the polyamide is in the composition. Consequently, the polyamide must be fluid at 292 rad·s⁻¹ and viscous at 0.292 rad·s⁻¹;
the viscosity at 292 rad·s⁻¹ is from 400 to 2000 and preferably from 600 to 1550;

The Rheotens force at 250° C. of the composition after compounding is from 22 mN to 200 mN, more particularly from 25 mN to 150 mN; this force determines the melt strength of the polyamide—the greater the force, the less the polyamide flows.

The Rheotens force can, for example, be determined with the aid of a Rheotens 71.97 instrument from Gottfert. A Rheotens instrument is a device equipped with notched wheels capable of pulling on a ring at the outlet of a Rheotester 2000 capillary rheometer from Gottfert: shearing at the capillary 100 s−1, die of L/D=30 and D=1 mm, temperature 250° C., distance between the outlet of the ring and the axle of the notched wheels 105 mm, acceleration of the wheels 2.4 mm/s⁻²
the degree of swelling at the outlet of the extruder of the composition after compounding is greater than 1.15, preferably greater than 1.2. The degree of swelling is realized according to the following procedure:
a 25 cm tubular parison is extruded using an extrusion blow line equipped with an accumulator. The rate of expulsion is set at 0.1 m/s, and the temperature of the extrudate is checked manually using a temperature probe. The diameter of the parison is measured at 10 cm below the die. 5 measurements are made to obtain an average. The temperature is chosen as a function of the flow characteristics of the polymer in order to limit the creep of the parison as much as possible.

The strength of the parison makes it possible to analyze the ability of the material to counterbalance the effect of gravity. Under its weight, a parison extruded horizontally or vertically will creep, thus modifying its dimensions. The resistance of the vertical parison of the composition after compounding is from 15 to 50 s, in particular from 20 to 45 s. These measurements were carried out as follows:

A parison of 1.2 kg and of length 190 mm is extruded with an expulsion rate set at 0.1 m/s. The time required for the length of the parison to increase by 40% by creep is measured. A long time will be representative of a viscous material. The temperature is chosen as a function of the flow characteristics of the polymer in order to limit the creep of the parison as much as possible.

According to a second aspect, the present invention relates to a monolayer or multilayer tubular structure intended for the transport, distribution or storage of gasoline, in particular alcohol-containing gasoline, comprising at least one sealing layer (1) comprising a composition as defined above.

The term “gasoline” denotes a mixture of hydrocarbons obtained from the distillation of petroleum, which may be admixed with additives or alcohols such as methanol and ethanol; in certain cases, the alcohols may be majority components.

The expression “alcohol-containing gasoline” denotes a gasoline to which methanol or ethanol has been added. It also denotes an E95 gasoline containing no petroleum distillation product.

In one embodiment of this second aspect, said tubular structure excludes a partially annealed flexible tubular structure which is located at least partly inside the fuel tank of a motor vehicle.

In another embodiment of this second aspect, said sealing layer, on first storage of fuel, has at most 1 g/m2, preferably 0.5 g/m2, of insoluble extract and also at most 15 g/m2, preferably 10 g/m2, of soluble extract being removed by washing of the single-layer or multilayer tubular structure as an overall system, determined according to the protocol described below, for a 20×4×4 cm3 tank having a wall thickness of 2 mm.

Using the composition of the invention in the sealing layer makes it possible to reduce greatly the proportion of extractables as determined by a test as defined above and more particularly by a test in which a tubular structure (tank) is filled with alcohol-containing gasoline of type FAM-B and the filled tank is heated at 60° C. for 96 hours, then drained with filtration into a beaker, after which the filtrate in the beaker is left to evaporate at ambient temperature, and lastly this residue is weighed; the proportion of the residue must be less than or equal to about 15 g/m2, preferably 10 g/m2, of the internal surface area of the tank.

The insoluble extracts present on filtration into the beaker are also weighed, and represent a maximum of 1 g/m², preferably 0.5 g/m2.

The alcohol-containing gasoline FAM B is described in the standard DIN 51604-1:1982, DIN 51604-2:1984 and DIN 51604-3:1984.

In essence, alcohol-containing gasoline FAM A is first prepared with a mixture of 50% toluene, 30% isooctane, 15% diisobutylene and 5% ethanol and then FAM B is prepared by mixing 84.5% of FAM A with 15% of methanol and 0.5% of water.

All in all, FAB consists of 42.3% toluene, 25.4% isooctane, 12.7% diisobutylene, 4.2% ethanol, 15% methanol and 0.5% water.

In yet another embodiment of this second aspect, said structure is single-layer.

In yet another embodiment of this second aspect, said structure is multilayer and comprises a barrier layer (3).

The expression “barrier layer” means a layer with very low permeability to fuels, especially to alcohol-containing gasolines, which therefore allows only very little of the fuel to pass into the atmosphere, especially the alcohol-containing gasolines.

More particularly, the expression “barrier layer” means that the proportion of gasoline, more particularly of alcohol-containing gasoline, which passes into the atmosphere is less than 20 g·mm/m2.day as determined with a fuel CE 10 at 60° C.

The gasoline permeability measurements are determined at 60° C. according to a gravimetric method with CE10: isooctane/toluene/ethanol=45/45/10 vol % and CE85:
isooctane/toluene/ethanol=7.5/7.5/85 vol % on plates consisting of a polymer material. The immediate permeability is zero during the induction period, but increases gradually until reaching an equilibrium value which corresponds to the steady-state permeability value. This value obtained in steady state is considered to be the permeability of the material.

This barrier property is indispensable for pipes or tanks in contact with the atmosphere.

Said barrier layer (3) is advantageously made of ethylene-vinyl alcohol (EVOH).

According to a third aspect, the present invention relates to the use of 0.05% to 10%, in particular from 0.1 to 9% by weight of at least one branching agent chosen from polyepoxides, polyanhydrides and polyisocyanates, in particular polymaleic anhydrides and polyepoxides, with 88 to 99.95%, in particular from 89 to 99.9% of at least one semicrystalline aliphatic polyamide having a carbon number per nitrogen atom of greater than or equal to 7, more particularly greater than or equal to 8, and optionally an additive for the constitution of a composition for blow-molding, as defined above, the melt viscosity of which after compounding is from 10 000 to 300 000 Pa·s, preferably from 15 000 to 220 000 Pa·s, as measured in plane-plane geometry according to ISO standard 6721-10:2015 at a temperature of 250° C., a frequency of 0.292 rad/s and a deformation of 2%.

The term “mono- or multi-layer tubular structure” is therefore understood to mean a tank comprising or consisting of one or more layers, namely a sealing layer and optionally one or more reinforcing layers, or a plurality of sealing layers and optionally a plurality of reinforcing layers, or a plurality of sealing layers and a reinforcing layer or else a sealing layer and a reinforcing layer.

The monolayer or multilayer tubular structure in the present invention also designates a pipe or tube intended for transporting hydrogen from the tank to the fuel cell and comprising or consisting of one or more layers, as defined above.

All the characteristics defined above for the first aspect concerning the composition are valid for this third aspect.

According to a fourth aspect, the present invention relates to a process for preparing a composition for blow-molding or extrusion, in particular blow-molding, as defined above, characterized in that it comprises a step of compounding said composition.

All the characteristics defined above for the first aspect concerning the composition are valid for this fourth aspect.

The compounding step is carried out in a particular manner so that the alloys have melt viscosities of from 10 000 to 300 000 Pa·s, preferably from 15 000 to 220 000 Pa·s, as measured in plane-plane geometry according to ISO standard 6721-10:2015 at a temperature of 250° C., a frequency of 0.292 rad/s and a deformation of 2%.

These viscosities may, for example, be obtained by compounding at a temperature of the molten polymer of greater than 280° C., preferably greater than 300° C., by increasing the residence time in the compounder. This branching reaction is advantageously catalyzed with, for example, phosphonium salts or hindered amines. The average residence time is advantageously from 20 seconds to 10 minutes, very advantageously from 45 seconds to 6 minutes.

In one embodiment, said compounding is carried out at a temperature of the molten polymer of greater than 280° C., preferably greater than 300° C. with an average residence time of from 20 seconds to 10 minutes, very advantageously from 45 seconds to 6 minutes.

According to a fifth aspect, the present invention relates to a process for preparing a monolayer or multilayer tubular structure as defined above, characterized in that it comprises a step of blow-molding or extrusion, in particular blow-molding, of a composition as defined above.

In one embodiment of this fifth aspect, the process comprises a preliminary step of compounding a composition as defined above.

The preliminary compounding step is in particular carried out as defined above.

All the characteristics defined above for the first aspect concerning the composition are valid for this fifth aspect.

### EXAMPLES

The comparative (CE1 to CE4) and inventive (C11 to C16) compositions of Table 2 below were prepared by compounding under the following conditions:

The alloys were manufactured using a ZSK 40 mm twin-screw extruder (Coperion). The temperature of the barrels was set to 280° C. and the screw speed was 300 rpm with a throughput of 60 kg/h.

The PA6 used is a polyamide 6 having an acid chain end concentration of 25 μeq/g and an amine chain end concentration of 22 μeq/g.

The PA610 used is a polyamide 610 having an acid chain end concentration of 27 μeq/g and an amine chain end concentration of 19 μeq/g.

The PA612 used is a polyamide 612 having an acid chain end concentration of 22 μeq/g and an amine chain end concentration of 20 μeq/g.

The PA11 used is a phosphoric acid-catalyzed polyamide 11 having an acid chain end concentration of 30 μeq/g and an amine chain end concentration of 33 μeq/g.

Joncryl ADR 4400 is from BASF.

Xibond 125 is from Polyscope.

Lotader 3410 is from SK functional polymer.

The stabilizer Anox NBD TL 89 is from SI group.

The melt viscosity was measured using an Ares G2 rotational rheometer equipped with a 25 mm plane-plane geometry at a temperature of 250° C., at 0.292 rad/s (residence time before launch 5 min under nitrogen, deformation of 2%, sweep of 628 rad/s at 0.062 rad/s and 3 points per decade, taking of a point on 3 cycles, gap of 1.5 mm).

The Rheotens force is determined using a Rheotens 71.97 instrument from Gottfert. A Rheotens instrument is a device equipped with notched wheels capable of pulling on a ring at the outlet of a Rheotester 2000 capillary rheometer from Gottfert, shear at the capillary 100 s⁻¹, die of L/D=30 and D=1 mm, temperature 250° C., distance between the outlet of the ring and the axle of the notched wheels 105 mm, acceleration of the wheels 2.4 mm/s⁻². The water uptake is determined either in an oven under a controlled atmosphere at 100% RH or in water, in all cases after saturation at 70° C., and the measurement of this water uptake is made by weighing the sample at 23° C., for regular sampling times, spaced several days apart, until an equilibrium state is observed, which is reached when the mass of the sample becomes constant (to within the measurement uncertainty) for three consecutive sampling times. In the case of conditioning in water, the equilibrium reached corresponds to the water saturation of the polymer, at a temperature of 70° C.

The resistance to ZnCl2/CaCl2 stress cracking was determined according to the protocol below:

Test specimens 1A having a thickness of 4 mm were clamped onto a mandrel with a radius of 32.5 mm and were then immersed for 300 h at 23° C. in a 50% ZnCl2 solution. The test specimen is then dried at 23° C. for 72 h. The specimens are subsequently analyzed by observation for the presence of stress cracking, and a stress cracking resistance score was awarded to each sample. 0: very low resistance, sample greatly cracked. 5: very good resistance, sample intact.

The CE1C permeability measurement involves measuring 30 ml of CE10 into a dish and then covering it with the 3 mm plate under evaluation. The assembly is placed in a temperature-controlled chamber. It is weighed periodically to determine the amount of solvent vapor which diffuses through the plate.

The flow, normalized with the surface area of the sample, is obtained by virtue of the slope of the curve for the change in weight (solvent) as a function of time.

The compositions of the invention and the comparative compositions were tested on several parameters.

The MFI, abbreviation for melt flow index, was measured according to ISO standard 1133:2011.

The results are detailed in Table 1.

TABLE 1

| | CE 1 | CE 2 | CE 3 | CE 4 | CI 1 | CI 2 | CI 3 | CI 4 | CI 5 | CI 6 |
|---|---|---|---|---|---|---|---|---|---|---|
| PA 6 | 76 | | | | | | | | | |
| PA 612 | | | | | | | | | 91 | |
| PA 610 | | | | | | | | | | 91 |
| PA 11 | | 99 | 84 | 84 | 98 | 98.5 | 94 | 91 | | |
| JONCRYL ADR | | | | | | 0.5 | | | | |
| 4400 | | | | | | | | | | |
| Xibond 125 | | | 15 | | 1 | | | | | |
| Lotader 3410 | 23 | | | 15 | | | 4 | 8 | 8 | 8 |
| Anox NBD TL 89 | 1 | 1 | 1 | 1 | 1 | 1 | 1 | 1 | 1 | 1 |
| total | 100 | 100 | 100 | 100 | 100 | 100 | 100 | 100 | 100 | 100 |
| viscosity at 0.292 | 9840 | 5819 | 7127 | 87302 | 191179 | 143026 | 23645 | 31047 | 30 267 | 28940 |
| rad/s | | | | | | | | | | |
| Stream of CE 10 | 9 | 17 | 16 | 25 | 16 | 17 | 18 | 20 | 17 | 15 |
| at 60° C. on | | | | | | | | | | |
| 100*100*3 mm | | | | | | | | | | |
| injected plates | | | | | | | | | | |
| (g. 3 mm/m2. 24 h) | | | | | | | | | | |
| Resistance to | 0 | 5 | 5 | 5 | 5 | 5 | 5 | 5 | 3.5 | 3 |
| ZnCl2/CaCl2 | | | | | | | | | | |
| stress cracking, 0-5 | | | | | | | | | | |
| (0 = poor, 5 = very | | | | | | | | | | |
| good resistance) | | | | | | | | | | |
| MFI | 0 | 6 | 6 | 0 | 0 | 0 | 0 | 0 | 0 | 0 |

The results show that the use of a branching agent in a particular range and of a polyamide with an average number of carbon atoms per nitrogen atom of greater than or equal to 7 makes it possible to obtain compositions exhibiting the best compromise on the various characteristics such as the viscosity at 250° C., permeability to gasolines and resistance to zinc chloride.

All the compositions according to the invention have an MFI equal to 0, which means that nothing flows into the machine.

1. A composition for blow-molding or extrusion comprising by weight:
a) from 88 to 99.95% of at least one semicrystalline aliphatic polyamide having a carbon number per nitrogen atom of greater than or equal to 7,
b) from 0.05% to 10% by weight of at least one branching agent chosen from polyepoxides, polyanhydrides and polyisocyanates,
c) from 0 to 2% of at least one additive, the composition having, after compounding, a melt viscosity of from 10,000 to 300,000 Pa·s, as measured in plane-plane geometry according to ISO standard 6721-10:2015 at a temperature of 250° C., a frequency of 0.292 rad/s and a deformation of 2%,
the sum of the constituents a)+b)+c) making 100% by weight.

2. The composition for blow-molding or extrusion as claimed in claim 1, wherein said compounding is carried out at a temperature of the molten polymer of greater than 280° C., with an average residence time of from 20 seconds to 10 minutes.

3. The composition for blow-molding or extrusion as claimed in claim 1, wherein the impact modifiers are excluded from said composition.

4. The composition for blow-molding or extrusion as claimed in claim 1, wherein the ratio of the viscosities as measured in plane-plane geometry in the melt state at 0.292 rad·s⁻¹/292 rad·s⁻¹ is from 10 to 200.

5. The composition for blow-molding or extrusion as claimed in one claim 1, wherein said branching agent has an average functionality in terms of epoxy, anhydride or isocyanate functions of from 1.8 to 200.

6. The composition for blow-molding or extrusion as claimed in one claim 1, wherein said branching agent has an average equivalent weight in terms of epoxy, anhydride or isocyanate functions of from 100 to 10,000 g/mol.

7. The composition for blow-molding as claimed in claim 1, wherein the Rheotens force of the composition after compounding is from 22 mN to 200 mN.

8. The composition for blow-molding or extrusion as claimed in claim 1, wherein said semicrystalline aliphatic polyamide is chosen from PA610, PA612, PA 614, PA 10, PA11 and PA12.

9. A monolayer or multilayer tubular structure configured for the transport, distribution or storage of gasoline, comprising at least one sealing layer comprising a composition as defined in claim 1.

10. The monolayer or multilayer tubular structure as claimed in claim 9, wherein said sealing layer, on first storage of gasoline, has at most 1 g/m2 of insoluble extract and also at most 15 g/m2 of soluble extract being removed by washing of the single-layer or multilayer tubular structure as an overall system, determined for a 20×4×4 cm3 tank having a wall thickness of 2 mm.

11. The monolayer or multilayer tubular structure as claimed in claim 9, wherein said structure is a monolayer structure.

12. The monolayer or multilayer tubular structure as claimed in claim 9, wherein said structure is a multilayer structure and comprises a barrier layer.

13. The monolayer or multilayer tubular structure as claimed in claim 12, wherein said barrier layer is made of EVOH.

14. A method of using 0.05% to 10% by weight of at least one branching agent chosen from polyepoxides, polyanhydrides, with 88% to 99.95% of at least one semicrystalline aliphatic polyamide having a carbon number per nitrogen atom of greater than or equal to 7, and optionally an additive for the constitution of a composition for blow-molding, as defined in claim 1, the melt viscosity of which after compounding is from 10,000 to 300,000 Pa·s, as measured in plane-plane geometry at a temperature of 250° C., a frequency of 0.292 rad/s and a deformation of 2%.

15. A process for preparing a composition for blow-molding or extrusion as defined in claim 1, comprising a step of compounding said composition.

16. A process for preparing a monolayer or multilayer tubular structure as defined in claim 9, comprising a step of blow-molding or extrusion of the composition.

17. A process for preparing a monolayer or multilayer tubular structure as claimed in claim 16, comprising a preliminary step of compounding the composition.
